(19) United States
(12) Patent Application Publication
(10) Pub. No.: US 2013/0085874 A1
(43) Pub. Date: Apr. 4, 2013

(54) METHOD AND SYSTEM FOR AUTOMATICALLY DISPENSING A PRODUCT

(71) Applicant: Les Enterprises Cafection Inc., Quebec (CA)

(72) Inventors: Simon GAGNE, Saint-Etienne-de-Lauzon (CA); Denis MAILLE, L'Ancienne-Lorette (CA)

(73) Assignee: LES ENTREPRISES CAFECTION INC., Quebec (CA)

(21) Appl. No.: 13/627,420

(22) Filed: Sep. 26, 2012

Related U.S. Application Data
(60) Provisional application No. 61/540,764, filed on Sep. 29, 2011.

(51) Int. Cl. B67D 7/74; G06Q 20/20; A47J 31/44

(52) U.S. Cl. 705/17; 222/129; 99/290; 222/1

(57) ABSTRACT

A product dispenser, comprising: a user interface for entering a selection of a desired product among available products by a user; a control unit operatively connected to the user interface for receiving the selection of the desired product, generating a command indicative of the desired product, and generating a barcode identifying the desired product; a dispenser unit for storing the available products and providing the user with the desired product upon reception of the command from the control unit; and a printing unit operatively connected to the control unit, the printing unit for printing the barcode on a coupon and providing the user with the coupon.

### TECHNICAL FIELD

This invention relates to the field of product dispensers, and particularly automatic product dispensers.

### BACKGROUND OF THE ART

Conventional product dispensers or vending machines are widely used for automatically dispensing products or items such as snacks, beverages, cigarettes, newspapers, consumer products, or the like. Usually, the user has to first pay for a desired product before receiving it. Such vending machines are useful for providing users with products in isolated areas but also in stores in order to provide the user with an additional service.

For vending machines installed in stores, the user pays at the vending machine for a desired item, grabs the item and leaves the store. Therefore, there is no incentive for the user of the vending machine to purchase another item present in the store, which limits the profitability of having such a vending machine for the owner of the store.

Furthermore, some usual vending machines have a payment interface comprising a slot for coins and an electronic slot for paper bills. Such vending machines require emptying by an owner or administrator, which is time consuming.

Therefore, there is a need for an improved system and method for automatically dispensing products or items to a user.

### SUMMARY

In accordance with a broad aspect, there is described a product dispenser, comprising: a user interface for entering a selection of a desired product among available products by a user; a control unit operatively connected to the user interface for receiving the selection of the desired product, generating a command indicative of the desired product, and generating a barcode identifying the desired product; a dispenser unit for storing the available products and providing the user with the desired product upon reception of the command from the control unit; and a printing unit operatively connected to the control unit, the printing unit for printing the barcode on a coupon and providing the user with the coupon.

In one embodiment, the barcode is indicative of at least one of a price of the desired product and an identification of the desired product.

In one embodiment, the coupon has further written information printed thereon, the written information comprising at least one of a name of the desired product and a time and a date at which the coupon has been printed.

In one embodiment, the product dispenser further comprises a communication unit for receiving and transmitting data to an administrator machine for remotely controlling the product dispenser from the administrator machine, at least one of the price and the identification for the available products being remotely changeable from the administrator machine.

In one embodiment, the control unit is adapted to store user consumption data and transmit the user consumption data to the administrator machine via the communication unit, the price and the identification for.

In the same or another embodiment, the product dispenser further comprises sensors for monitoring at least one of malfunctions and an amount of remaining products, the control unit being further adapted to transmit indications of the at least one of malfunctions and an amount of remaining products to the administrator machine via the communication unit.

In one embodiment, the product dispenser further comprises an identifier reader for identifying the user.

In one embodiment, the dispenser unit is adapted to prepare beverages according to recipes stored in the control unit.

In one embodiment, the dispenser unit comprises a storage module for storing coffee beans, a grinder module for grinding the coffee beans received from the storage module, a hot water module connectable to a source of water and adapted to heat water, and a brewer module for brewing the ground coffee received from the grinder module in the hot water received from the hot water module.

In one embodiment, the dispenser unit further comprises a cup ejecting module for storing cups and ejecting a given one of the cups on a platform.

According to another broad aspect, there is provided a method for generating a coupon indicative of a purchase, the method comprising: receiving at an automatic product dispenser a selection for a desired product among available products, the selection being provided via a user interface of the automatic product dispenser; generating a barcode identifying the desired product; printing the barcode on a coupon; and providing the selected product and the coupon having the barcode printed thereon.

In one embodiment, the step of generating a barcode comprises generating a barcode indicative of at least one of a price of the desired product and an identification of the desired product.

In one embodiment, the method further comprises a step of printing written information on the coupon, the written information comprising at least one of a name of the desired product and a time and a date at which the coupon has been printed.

In one embodiment, the method further comprises receiving and transmitting data to an administrator machine so that the automatic product dispenser be remotely controllable from the administrator machine, at least one of the price and the identification for the available products being remotely changeable from the administrator machine.

In one embodiment, the method further comprises steps of storing user consumption data and transmitting the user consumption data to the administrator machine.

In one embodiment, the method further comprises steps of monitoring at least one of malfunctions and an amount of remaining products and transmitting the at least one of malfunctions and an amount of remaining products to the administrator machine.

In one embodiment, the method further comprises a step of identifying a purchaser of the desired product.

In one embodiment, the step of providing the user with the selected product comprises preparing a desired beverage according to a recipe stored in the automatic product dispenser.

In one embodiment, the step of preparing the desired beverage comprises: storing coffee beans in a storage module; grinding the coffee beans received from the storage module, thereby obtaining ground coffee; heating water to a desired temperature, thereby obtaining hot water; brewing the ground coffee in the hot water, thereby obtaining a brewed coffee.

In one embodiment, the method further comprises: storing cups in a cup ejecting module; ejecting one of the cups on a platform; and pouring the brewed coffee in the ejected cup.

In one embodiment, the product dispenser is an automatic beverage dispenser adapted to prepare and deliver beverages such as coffees, teas, hot chocolates, and the like. In this case, the automatic beverage dispenser is connectable to a source of liquid such as a source of water for example.

The dispenser unit may be adapted to prepare beverages using coffee beans and/or soluble products. The dispenser unit may comprise a grinder module for grinding the coffee beans and a brewer module.

The beverage dispenser may also comprise a communication unit so that information may be remotely uploaded via an Internet connection for example.

The cost of each beverage combination can also be remotely updated via the communication unit. In this case, the control unit is adapted to generate a new barcode for each beverage combination in accordance with the newly received costs.

The control unit may also store usage data on the memory. The usage data may be remotely accessed through the communication in order to generate statistical data indicative of the consumers habits. The data may also be used for inventory purposes and to track success of promotional campaigns for example. It can also be used to schedule maintenance.

A barcode is an optical machine-readable representation of data, which shows data such as price for example about a corresponding product or item. It should be understood that a barcode may have different shapes, for example, a barcode may be linear or 1 dimensional (1D). In this case, the barcode parallel lines have a varying width and spacing. A barcode may also be 2 dimensional (2D) such as a QR code, and comprise rectangles, dots, hexagons, and/or the like.

### BRIEF DESCRIPTION OF THE DRAWINGS

In order that the invention may be readily understood, embodiments of the invention are illustrated by way of example in the accompanying drawings.

FIG. 1 is a block diagram of an automatic product dispenser, in accordance with an embodiment;

FIG. 2 is a flow chart illustrating a method for automatically providing a user with a particular product, in accordance with an embodiment;

FIG. 3 illustrates an automatic beverage dispenser having a front door, in accordance with an embodiment;

FIG. 4 illustrates the automatic beverage dispenser of FIG. 3 without the front door;

FIG. 5 illustrates a partially exploded view of the automatic beverage dispenser of FIG. 3;

FIG. 6 illustrates a brewer module contained in the automatic beverage dispenser of FIG. 3, in accordance with an embodiment;

FIG. 7 illustrates an insertion of a printing unit module in the front door of the automatic beverage dispenser of FIG. 3, in accordance with an embodiment;

FIG. 8 includes FIGS. 8a and 8b and illustrates the printing unit module of FIG. 7 in a closed position and an open position, respectively;

FIG. 9 illustrates a method for automatically providing a user with a desired beverage, in accordance with an embodiment; and

FIG. 10 illustrates a coupon on which is printed a barcode, in accordance with an embodiment.

Further details of the invention will be apparent from the detailed description included below.

### DETAILED DESCRIPTION

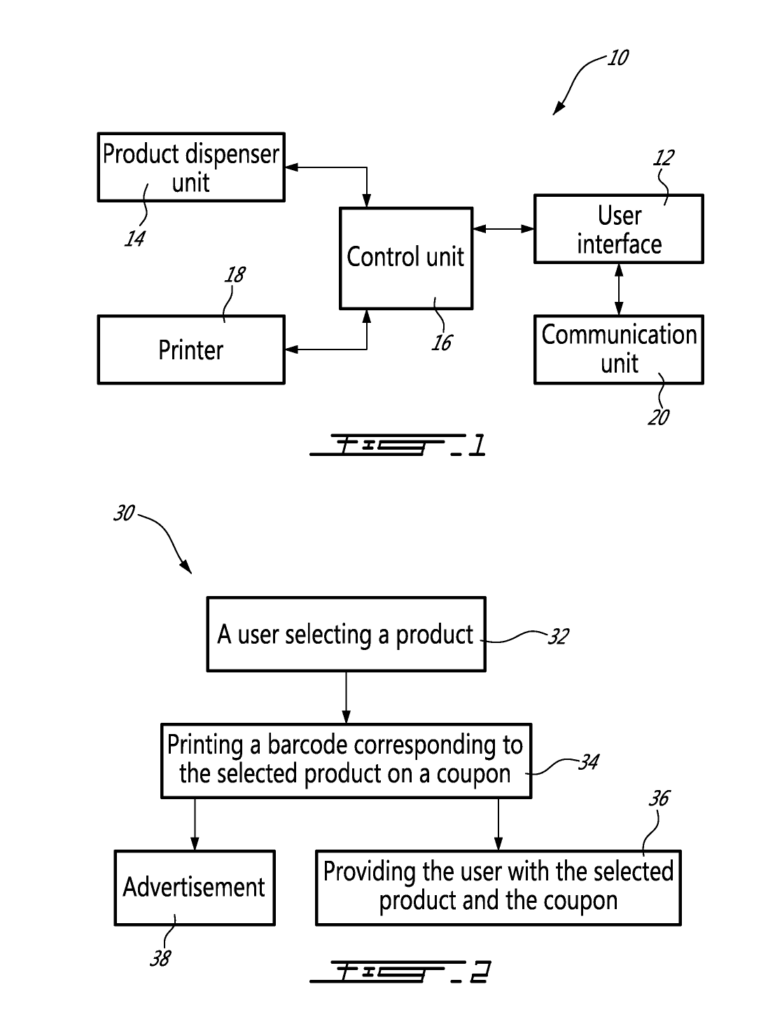

FIG. 1 illustrates one embodiment of a vending machine or automatic product dispenser 10 for automatically providing a user with a desired product or item. The automatic product dispenser 10 comprises a user interface 12, a control unit 16, a product dispenser unit 14, and a printing unit 18.

The user interface 12 is adapted to display a list of available products and receive a selection of a desired product from a user. It should be understood that any adequate user interface allowing the user to enter a selection of a desired item may be used. In one embodiment, the user interface 12 comprises a keyboard comprising a plurality of keys to be activated by the user for entering his selection. Each key may be associated with a corresponding item. Alternatively, the user may successively depress a plurality of keys for selecting a desired item. In another embodiment, the user interface 12 comprises a touch screen for displaying a keyboard and/or options to the user. For example, the touch screen may display a plurality of keys each associated with a corresponding item. In this case, the user simply touches a single key corresponding to his desired item. Alternatively, the user touches at least two keys for selecting his desired item. For example, the user may enter the combination “A”+“7” for selecting a particular desired product. The user may also sequentially select a plurality of keys each associated with a different property/characteristic for the desired item. For example, in the case of a beverage, the user may select a desired type of coffee, a country of origin for the coffee beans, a cup size, an amount of milk, an amount of sugar, etc. by sequentially depressing a plurality of keys. In another example, the touch screen may display images each representing a corresponding item. In this case, the user selects his desired item by touching the corresponding image displayed on the touch screen. In another embodiment, the displayed images may correspond to options/characteristics so that the user may have to touch a plurality of images to select a desired item.

In the same or another embodiment, the user interface may comprise an identifier (ID) reader for identifying the user. The ID reader may be a radio frequency (RF) reader adapted to read RFID cards, codes or tags, a barcode reader, or the like. In an embodiment in which the vending machine 10 is adapted to deliver beverages, the ID reader may be adapted to read a RFID code or tag printed on or included within the personal cup or glass of the user. The personal cup or glass then serves as the ID for the user. While it may identify the user for providing the user access to the product dispenser 10 for example, the ID stored on the ID tag may also correspond to a particular item or product. In this case, the ID tag may be used for selecting a desired item. The user interface 12 reads the item ID stored on the ID tag and automatically provides the user with the item corresponding to the ID stored on the ID tag. It should be understood that a confirmation message for the desired item may be displayed on the user interface 12 before providing the user with the desired item.

The product dispenser unit 14 is adapted to store and/or prepare a plurality of products, and provide the user with a selected product. It should be understood that the products to be dispensed by the product dispenser unit 14 may be of various types. For example, the product dispenser unit 14 may be adapted to store a plurality of snacks and dispense a particular snack to the user upon selection thereof via the user interface 12. In another embodiment, the product dispenser unit 14 may be adapted to prepare a plurality of beverages such as soft drinks, soups, coffees, teas, and the like. In this case, the product dispenser unit 14 may store powder products and be adapted to mix the powder products with liquids such as water or milk for example to obtain beverages.

The control unit 16 is operatively connected to the user interface 12 and the product dispenser unit 14. The control unit 16 is adapted to receive the user selection for the desired product from the user interface 12 and control the product dispenser unit 14 for dispensing the selected product. In one embodiment, the control unit 16 comprises a processing unit and a memory. The processing unit is configured for receiving the product selection from the user interface 12 and generating a command indicative of the selected product, which is then sent to the product dispenser unit 14. Upon reception of the command, the dispenser unit 14 dispenses the selected item.

The processing unit of the control unit 16 is further configured for generating a barcode corresponding uniquely to the selected item, which is printed on a coupon or ticket by the printing unit 18. The barcode may be indicative of the selected item and/or a characteristic of the selected item such as the price of the selected item. In one embodiment, the barcode may be indicative of an identification (ID) of the selected item. In this case, the memory of the control unit 16 comprises a database stored thereon, and the database comprises a respective ID for each available item. In the same or another embodiment, the barcode may be indicative of the price of the selected item. In this case, the memory of the control unit 16 comprises a database stored thereon, and the database comprises a respective price for each available item.

An example of a coupon bearing a printed barcode indicative of a price is shown in FIG. 10. As illustrated in FIG. 10, a coupon may comprise further information in addition to the barcode. In the case the selected item is a coffee, the type of coffee that has been selected, the cup size, the price of the selected coffee, the date and time at which the coupon has been printed may be written on the coupon in addition to the logo/name of the fabricant of the vending machine 10.

Once the barcode is printed on the ticket, the user is provided with the ticket. After being provided with his selected item and the ticket, the user has to present the ticket to a cashier who will scan the ticket to read the barcode using a conventional barcode reader and charge the user for the price associated with the selected item. In an embodiment in which the barcode is only indicative of the selected item, then the point-of-sale system has stored thereon a database comprising available items and corresponding prices. Once the coupon has been scanned by the cashier, the point-of-sale system receives data indicative of an identification of the selected item and retrieves the corresponding price from the database. In an embodiment in which the barcode is indicative of the price, the point-of-sale receives data indicative of the price directly from the barcode reader once the cashier has scanned the coupon. In a further embodiment, the barcode may be indicative of a level of price. In this case, the level of price is sent to the point-of-sale from the barcode reader and the point-of-sale retrieves the price corresponding to the price level from a database comprising a corresponding price for each price level. After determining the price using the data received from the barcode reader, the point-of-sale system receives a payment from the user. It should be understood that any adequate payment methods may be used. For example, the user may pay using a debit card, a credit card, etc. It should also be understood that the user may purchase products other than the product delivered by the automatic product dispenser. In this case, the payment may cover both the product delivered by the automatic product dispenser and the other products.

Because he has to physically go to the cash register and may have to wait in line, the user will be exposed to other products present in the store and may be inclined to buy other products that he would probably have not noticed if he would have paid for the product directly at the automatic dispenser 10 and left the store immediately after receiving the product. Therefore, the profitability of the automatic dispenser 10 is increased since it allows for selling additional products. In addition, no emptying of the automatic dispenser 10 by an owner or administrator is required since no coins or bills are inserted in the automatic dispenser 10.

In one embodiment, applications may be stored on the memory of the control unit 16 and coupled to the processing unit. In one embodiment, an application allows for storing consumers habits. In this case, the processing unit is configured for storing user consumption information such as the number/quantity of dispensed items for each available product over a given period of time.

In one embodiment, the user interface 12 comprises a screen on which advertising is displayed. For example, advertising videos stored on the memory of the control unit 16 may be displayed on the screen.

In one embodiment, the automatic dispenser 10 further comprises a communication unit 20 for remotely communicating with a server via the Internet for example. The communication unit 20 may be a wireless communication unit such as a Wi-Fi communication unit, a cellular modem, a Wide Area Network (WAN) communication unit, or the like. In this case, configuration, management, and control of the vending machine may be remotely performed. For example, activities such as data collection, trouble-shooting, application updates, information upload such as advertising video upload and/or item information upload, and the like may be remotely performed. For example, consumption habit data may be transmitted to a remote server from the control unit 16 to the remote server via the communication unit 20 so that analysis of the consumption usage may be performed on the remote server and/or maintenance for the automatic dispenser 10 may be determined. In another example, the price of a given item may be remotely changed from the remote server.

In one embodiment, the dispenser unit 14 is provided with switches and/or sensors for detecting the malfunction of the dispenser 10, determining the amount of remaining products, and/or the like. In this case, such information can be transmitted to the remote server via the communication unit 20.

While the above description refers to upload/download of information from a remote server, it should be understood that other configurations are possible. For example, information may be uploaded to and/or downloaded from the vending machine 10 by connecting thereto a storing unit, such as a USB key, or an administrator/owner computer.

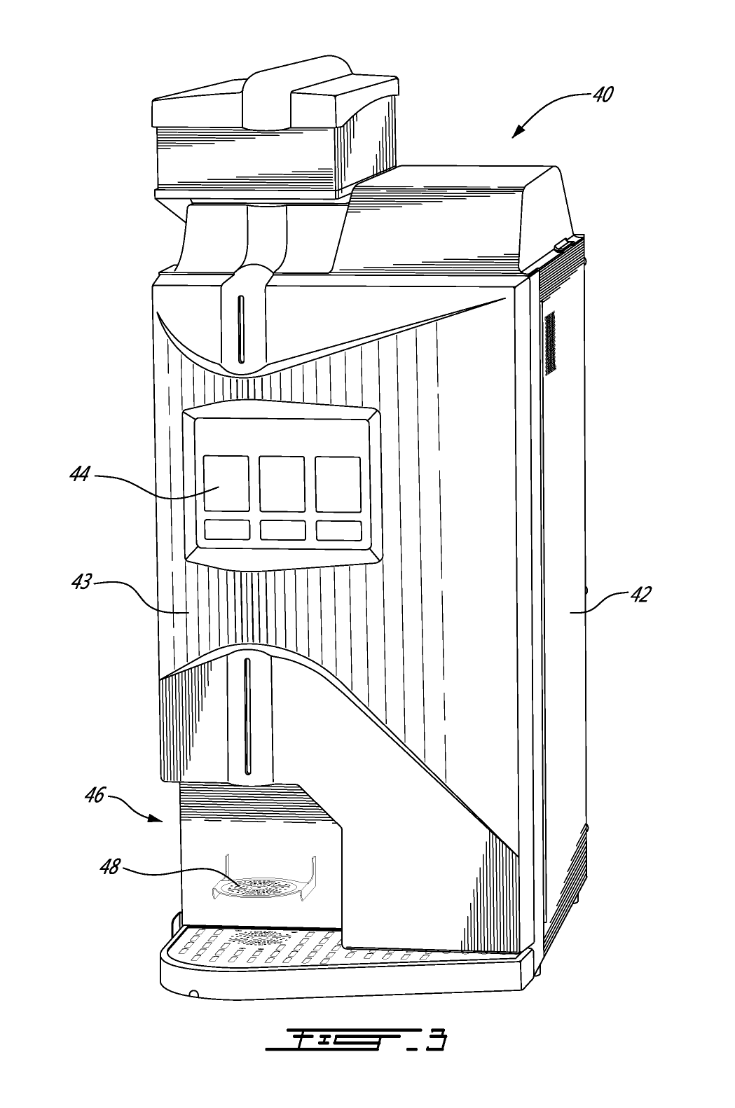

FIG. 2 illustrates one embodiment of a method 30 for automatically providing a user with a selected item. At step 32, the user enters a selection for a desired item at an automatic product dispenser, using the user interface 12 of the product dispenser 10 for example. At step 34, a barcode uniquely corresponding to the selected product is generated and printed on a ticket or coupon. For example, the barcode may be indicative of the price of the selected item. At step 36, the user is provided with the selected item and the coupon having the corresponding barcode printed thereon. At step 38, advertisement can be displayed on the user interface.

It should be understood that the selected item and the coupon may be delivered to the user substantially concurrently. In another embodiment, the user may be first provided with the selected item and subsequently with the coupon. In a further embodiment, the coupon is first delivered and the user is subsequently provided with the selected item.

In the following, there is described one example of an automatic product dispenser 10 adapted to dispense beverages such as coffees and teas.

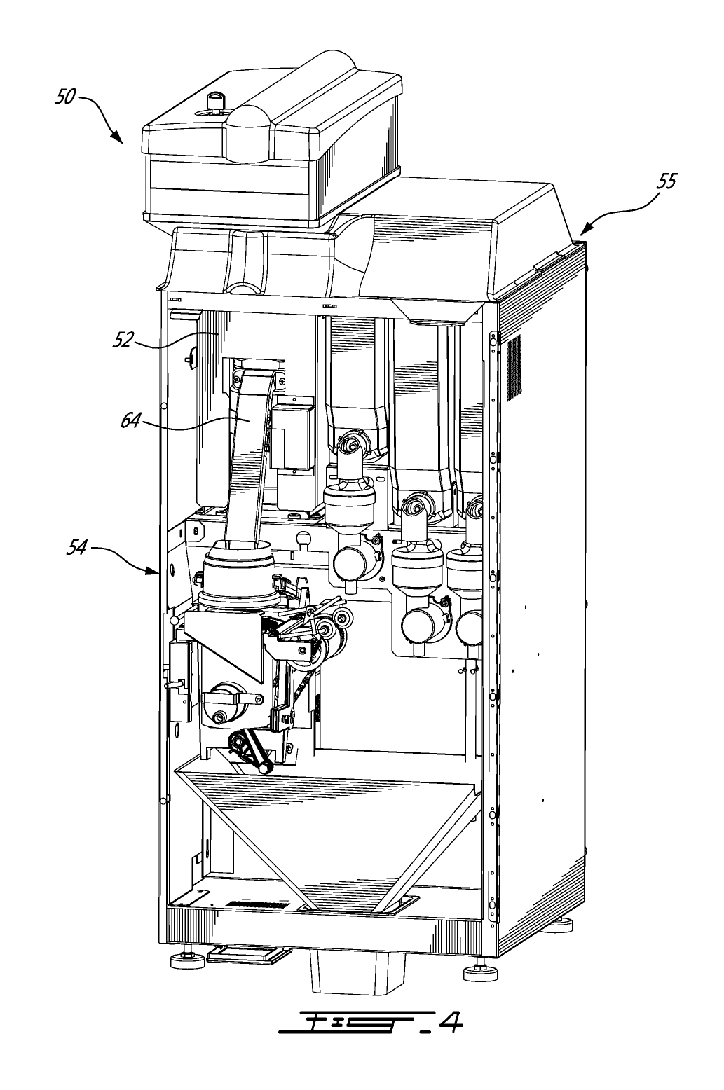

FIG. 3 illustrates one embodiment of an automatic beverage dispenser 40 adapted to dispense beverages such as coffees, teas, hot chocolates and the like. The beverage dispenser 40 comprises a frame 42 having a front door 43, in which a dispenser unit, a printing unit, a control unit, and a communication unit are enclosed. The front door 43 comprises a touch screen user interface 44 in communication with the control unit, and the frame 42 comprises a recess portion 46 in which a cup receiving platform 48 is secured.

In one embodiment, a user positions a cup on the platform 48 before selecting a desired beverage using the user interface 44. Alternatively, the beverage dispenser 40 may further comprise a cup ejecting unit adapted for storing cups or containers and ejecting a cup on the platform 48 before the beverage dispenser 40 dispenses a beverage therein. It should be understood that the cup ejecting unit may be adapted to store and eject cups having different sizes.

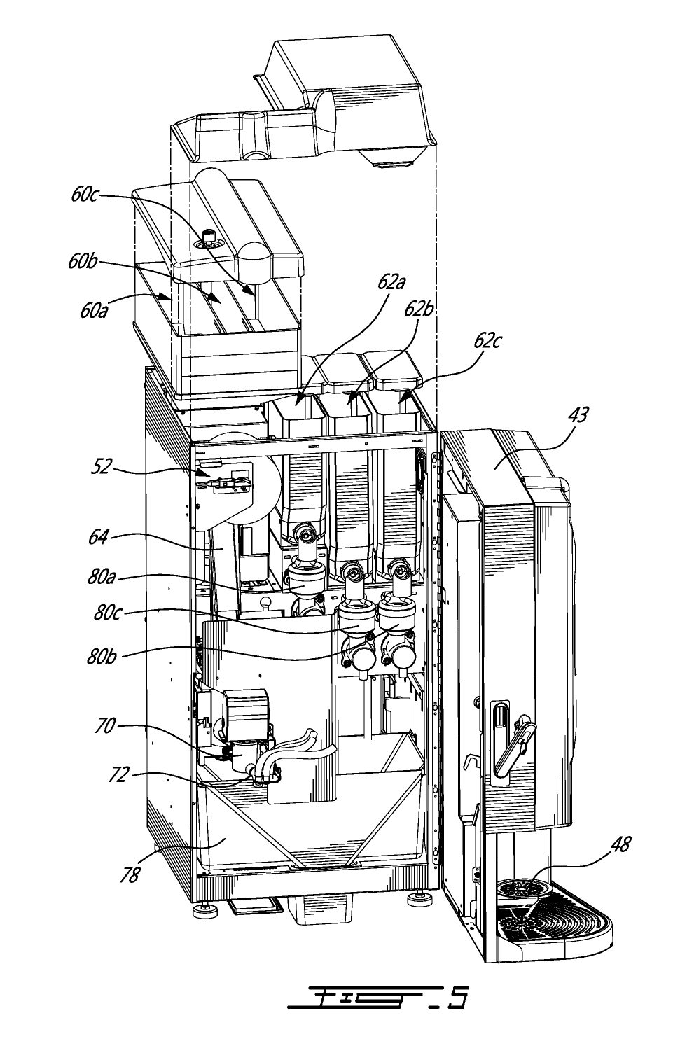

As illustrated in FIGS. 4 and 5, the dispenser unit comprises a storage module 50, a grinder module 52, a brewer module 54, and a hot water module 55. The hot water module 55 is located within the frame 42 of the automatic beverage dispenser 40 and is accessible via a rear panel opposite to the front door. The hot water module 55 is connectable to a source of water and comprises a heater controlled by the control unit for heating water, a tank for storing the hot water, and accessories, such a pump for example, for delivering the hot water.

In the illustrated embodiment, the storage module 50 comprises three storage compartments 60a, 60b, and 60c for storing three different types of whole bean coffees for example, and three storage compartments 62a, 62b, and 62c for storing soluble products such as soluble chocolate powder, soluble milk powder, and soluble vanilla flavor powder for example. A cover A is used for enclosing the coffee beans in their respective storage compartments 60a, 60b, and 60c while three different covers B, C, and D are used for covering the storage compartments 62a, 62b, and 62c.

The storage compartments 60a, 60b, and 60c are connected to the grinder module 52 and a movable door or valve operatively connected to a motor is positioned between each storage compartment 60a, 60b, 60c and the grinder module 52. The control unit controls the opening of each valve via its corresponding motor for controlling the amount of coffee beans to be delivered to the grinder module 52.

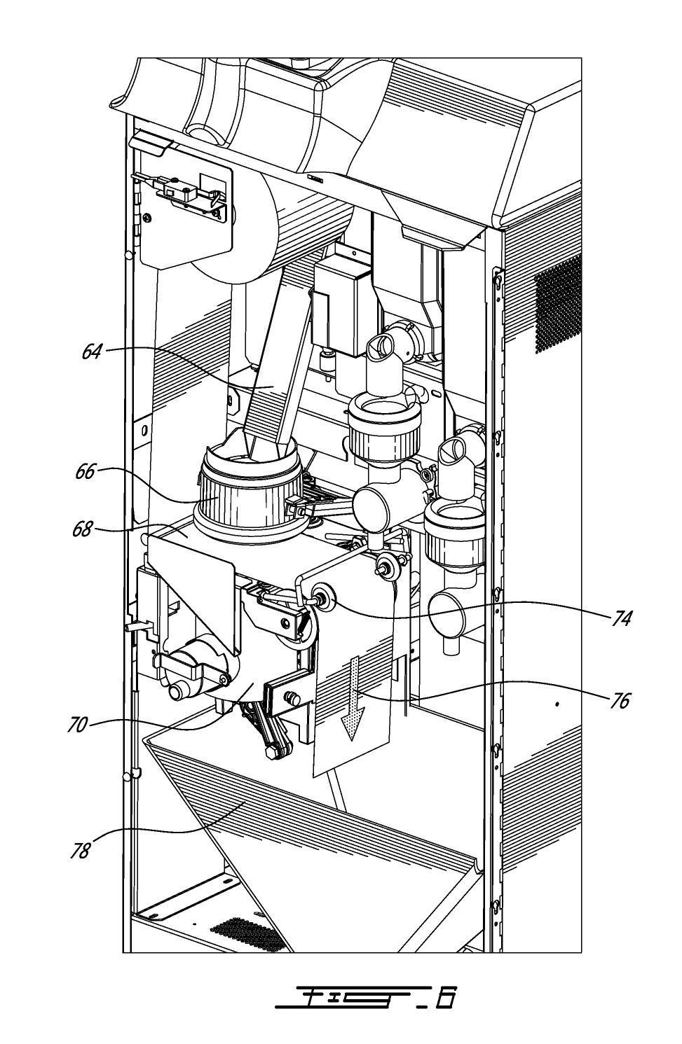

The operation of the grinder module 52 is also controlled by the control unit. The grinder module 52 grinds the received amount of coffee beans, and a chute 64 delivers the ground coffee to the brewer module 54. Referring to FIGS. 5 and 6, the brewer module 54 comprises a funnel 66, a roll of filter paper 68, a reservoir 70, and a fluidic connection 72 in the shape of a tap, which is fluidly connected to the reservoir 70. The fluidic connection 72 extends in the recess portion 46 of the frame 42 on top of the cup receiving platform 48 for delivering the beverage in a cup positioned on the platform 48. The filter paper 68 is positioned between the funnel 66 and the reservoir 70 so that the ground coffee coming from the chute 64 is delivered in the funnel 66 in order to fall on the filter paper 68. Once the ground coffee is delivered in the funnel 66 or concurrently while the ground coffee is being delivered in the funnel 66, hot water coming from the hot water module is delivered in the funnel 66 in order to brew the ground coffee. The resulting coffee passes through the filter paper 68 and falls in the reservoir 70 before falling in the cup positioned on the platform 48 via the fluidic connection 72.

As illustrated in FIG. 6, the brewer module 54 comprises at least one roll 74 operatively connected to a motor controlled by the control unit. The roll 74 is used for unrolling the filter paper 68 which advances according to arrow 76. Once the coffee has been delivered in the cup, the control unit activates the roll 74 so that the filter paper 68 advances according to arrow 76 and the waste or superfluous coffee falls in the waste container 78.

The brewer module 54 also comprises three mixing chambers 80a, 80b, and 80c connected to a respective storage compartment 62a, 62b, 62c. A valve is also positioned between each storage compartment 62a, 62b, 62c and its respective mixing chamber 80a, 80b, 80c. Each valve is controlled by the control unit for delivering a given amount of soluble product in its corresponding mixing chamber 80a, 80b, 80c. The mixing chambers 80a, 80b, and 80c are fluidly connected to the hot water module so that hot water may be delivered in the mixing chamber 80a, 80b, 80c to mix with the soluble product.

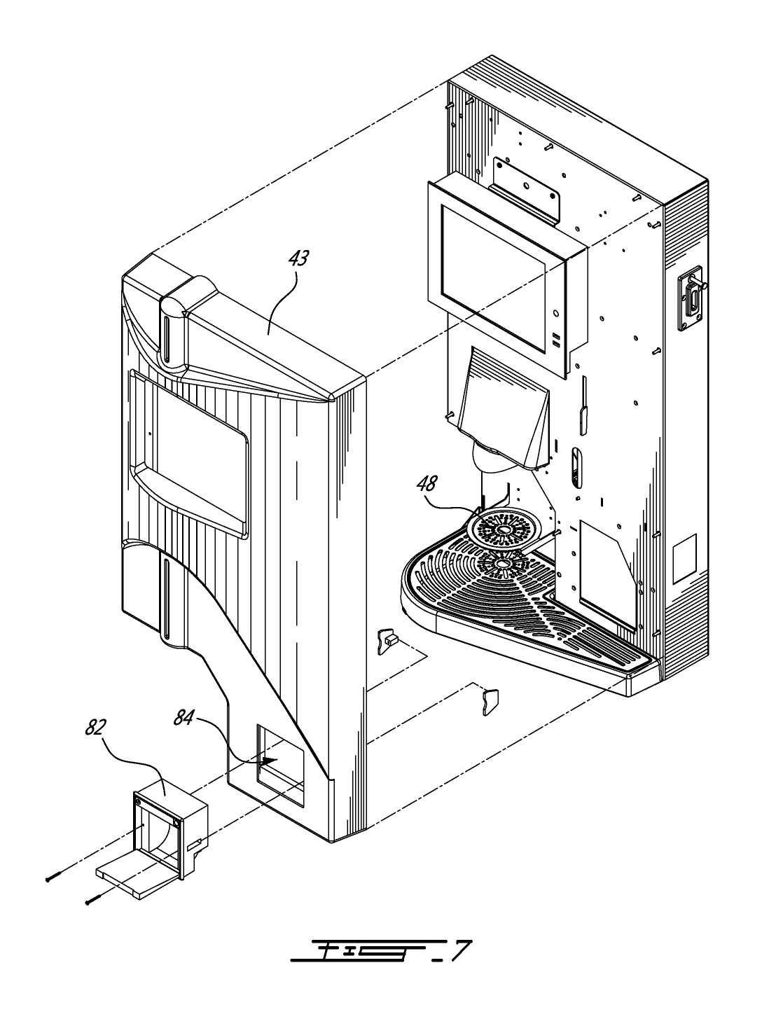

The beverage dispenser 40 further comprises a printing unit 82 for providing the user with a coupon having a barcode printed thereon, as illustrated in FIG. 7. The printing unit 82 is removably securable to the door 43 of the beverage dispenser 40. The door 43 is provided with an opening 84 therethrough which faces the printing unit 82 when secured to the door 43 in order to provide users access to the printed coupons.

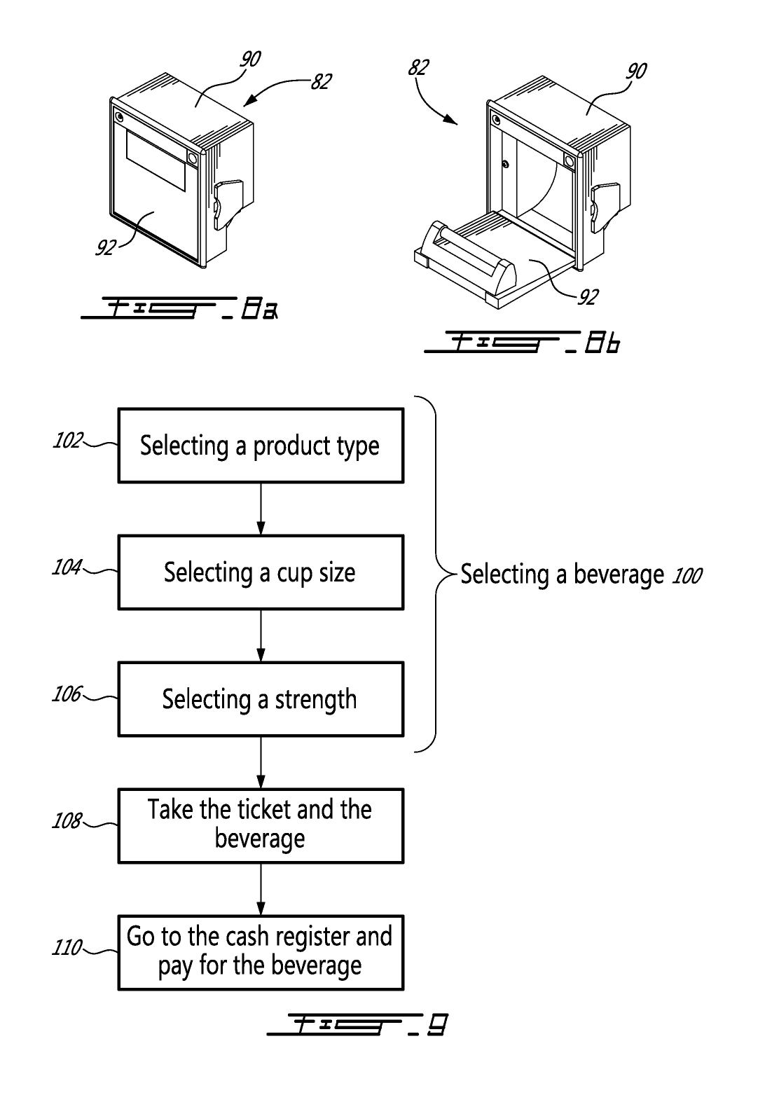

In one embodiment, the printing unit 82 comprises a frame 90 having a panel 92 movable between an open position in which tickets or coupons may be inserted in the printing unit 82, and a closed position, as illustrated in FIGS. 8a and 8b. The printing unit 82 further comprises a printing unit adapted to print barcodes on the tickets. The printing unit 82 is further adapted to deliver the ticket through the opening 84 once the barcode has been printed.

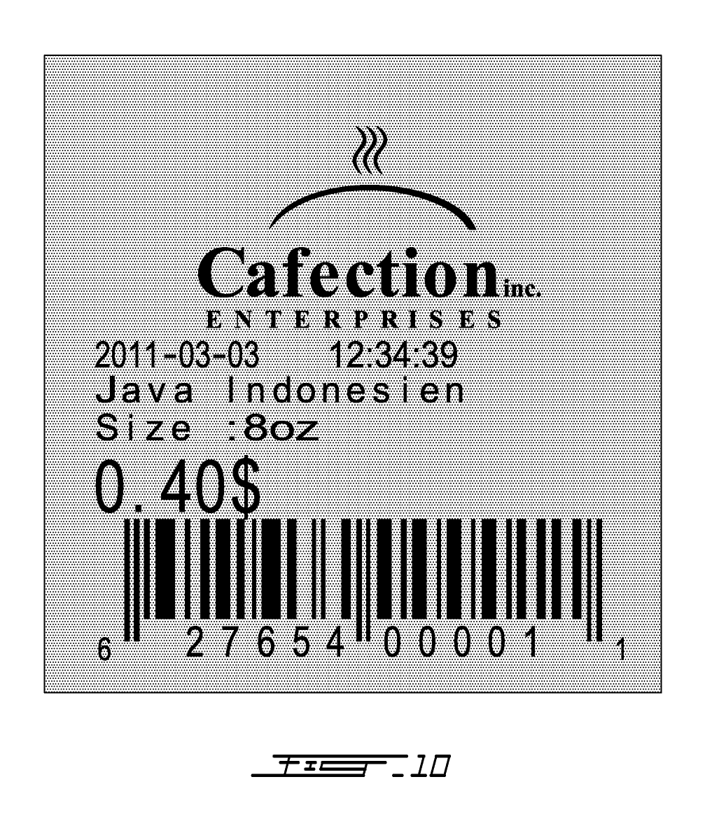

It should be understood that the different components of the beverage dispenser 40 are controlled by the control unit. The control unit receives a selection of a desired beverage from the user interface 44. For example, the selection of a beverage may comprise the selection of different options by the user, as illustrated in FIG. 9. At step 102, the user selects a beverage type such as “coffee” for example. Then, the user selects a cup size and a strength level for the coffee, at steps 104 and 106, respectively. Upon reception of the beverage selection, the control unit determines beverage parameters such as the volume of hot water for the selected beverage, the type and amount of coffee beans to be ground, and/or the amount of soluble products required for the beverage, if any. The control unit then sends commands indicative of the parameters to the storage module 50 and the hot water module. For example, if no chocolate, milk, or vanilla flavor powders are required for the desired beverage, the control unit sends a command indicative of the type and the amount of coffee beans to be ground to the storage module 50 which delivers the exact amount of the particular type of coffee beans to the grinder module 52. Then, the control unit sends an activation command to the grinder module 52 for grinding the coffee beans. In one embodiment, the control unit controls the operation duration of the grinder module. In this case, the control unit may activate the grinder module 52 for a predetermined period of time as a function of the amount of coffee beans to be ground. In another embodiment, the grinder module automatically stops when all of the coffee beans have been ground.

The ground coffee falls in the funnel 66 of the brewer module 54. Then the control unit sends to the hot water module a command indicative of the volume of water to be delivered to the brewer module 54. The control unit determines the volume of hot water using the options selected by the user such as the selected cup size for example. The coffee is brewed in the funnel 66 and passes through the filter 68 before falling in the cup. Before, after, or concurrently with the preparation of the coffee, the control unit generates a barcode corresponding to the selected beverage and indicative of the selective beverage and/or its price. The control signal sends a command indicative of the generated barcode to the printing unit 82 which prints the barcode on a ticket and provides the user with the printed ticket. As illustrated in FIG. 10, additional written information such as the name of the selected beverage, the cup size, the time and date at which the coupon has been printed, and/or the like may be printed on the coupon. After the infusion of the coffee, the control unit sends a command to the roll 74 controlling the filter paper 68 to evacuate the coffee in the waste container 78 and position a new filter below the funnel 66 for a next coffee preparation.

At step 108, the user grabs the cup having the selected coffee therein and the ticket having the barcode printed thereon, and goes to the cash register or cashier at step 110. Then, the user presents the ticket to a cashier who scans the barcode using a conventional barcode reader and charges the user for the price of the exact selected beverage.

In one embodiment, the control unit comprises a processing unit and a memory. The different options for the beverages and recipes are stored on the memory. The processing unit is configured for receiving the beverage selection from the user interface and sending commands to the other components of the beverage dispenser 40 in order to deliver the selected beverage.

In one embodiment, the beverage dispenser 40 further comprises sensors for monitoring the functioning of the different components. For example, the platform 48 may be provided with a position sensor for determining whether or not a cup is positioned on the platform 48. In this case, the control unit 16 is adapted to start the delivery of a selected beverage if the position sensor detects that a cup is positioned on the platform 48. The beverage dispenser 40 may also comprise sensors for determining the remaining amount of coffee beans and soluble products present in the storage compartments 60a, 60b, and 60c, and 62a, 62b, and 62c, respectively. When the amount reaches a minimum threshold, the control unit 16 informs an administrator of the beverage dispenser 40 via a visual indicator on the user interface 12 for example.

Other sensors are possible. For example, the beverage dispenser 40 may comprise an overflow frip tray for detecting a spillage inside the frame 42, an overflow cup for detecting a reservoir leakage, a cam position sensor for detecting the position of the brewer module, a filter paper sensor for detecting whether paper is present or missing, a proximity sensor for detecting if canister is present, a capacitive sensor for detecting if soluble product is present in the storage compartment, a water level sensor for determining the level of hot water in the hot water tank, and/or the like.

In one embodiment, the beverage dispenser 40 comprises a communication unit 20 such as a RF communication unit for communication with a remote server. In this case, the information contained on the memory such as processing unit applications, beverage recipes, advertising contents to be displayed on a display of the user interface, and the like, may be remotely updated/uploaded via an Internet connection for example. Therefore, an administrator may remotely control, manage, and configure the beverage dispenser 40.

For example, an operator of the automatic beverage dispenser 40 may remotely modify the recipe of a beverage such as a coffee. For example, the operator may remotely set the amount of coffee to be ground for a given cup size. This may be achieved by adjusting an opening time for the valve connecting the storage compartment 60a, 60b, 60c and the grinder module 52. In another example, the operator may remotely set a given coffee strength, the volume of water for a given cup size, the amount of soluble product for a given cup size, etc. The operator may also remotely set the parameters of the automatic beverage dispenser 40 such as the water warming up temperature, the volume of beverage per cup size, etc. The operator may also remotely set the parameters for a brew cycle. For example, the operator may remotely set desired standby time periods (i.e. periods of time during which no water is in contact with the ground coffee) and active time periods (i.e. periods of time during which hot water is in contact with the ground coffee) in order to modify the final taste of the coffee beverage.

The cost of each beverage combination can also be remotely updated via the communication unit 20. In this case, the control unit 16 is adapted to generate a respective new barcode for each beverage combination in accordance with the newly received costs.

The control unit may also store usage data on the memory. The usage data may be remotely accessed through the communication in order to generate statistical data indicative of the consumers' habits. The data may also be used for inventory purposes and to track success of promotional campaigns for example. It can also be used to schedule maintenance. For example, an operator of the automatic beverage dispenser 40 may remotely access the number of sales over a given period of time for each available beverage, the number of free beverages delivered during the given period of time, if any, and the like.

As will be readily understood, some or all of the beverages could be dispensed for free for a predetermined or indefinite period of time. In the case wherein a user orders a free beverage, the printed coupon delivered to the user bears a barcode which is indicative of a zero dollar price or of a free beverage.

In one embodiment in which the beverage dispenser 40 is provided with sensors for monitoring the remaining amounts of coffee beans and soluble products, the control unit may be adapted to send a maintenance signal to the administrator via the communication unit when an amount reaches its corresponding minimum threshold. Therefore, the administrator is informed that the automatic beverage dispenser 40 should be refilled.

In one embodiment, it is also possible to enter a programming mode by activating a proper sequence on a touch screen of the user interface or by activating a hardware lock within the casing of the machine. Once in the programming mode, the control unit can be controlled via the touch screen of the user interface.

In one embodiment, the beverage dispenser 40 can be equipped with an RFID sub-system connected to the control unit. The users could then be provided with a beverage container or cup equipped with an RFID chip such as an RFID tag. Once the beverage container in proximity of the beverage dispenser 40, the RFID sub-system would recognize the RFID signal and identify the user. The beverage preferences of the user could be stored on the RFID chip. The control unit receives the user preferences and immediately sends commands to the other components of the beverage dispenser 40 in accordance with the user preferences in order to prepare the right beverage. This user profile would also allow tracking beverage consumption data associated with the user to provide the user with his data or for the owner or administrator of the machine. In one embodiment in which a user is provided with a container having an RFID chip, no barcode is generated by the control unit so that the user is not provided with a ticket. In this case, the purchase of the beverage could be immediately charged to the user account via the internet for example.

It should be understood that variations of the beverage dispenser 40 may be made. For example, while it comprises a grinder module 52 for grinding coffee beans, it should be understood that the beverage dispenser 40 may be adapted to prepare instant coffee so that the grinder module 52 may be omitted.

Although the above description relates to example embodiments as presently contemplated by the inventors, it will be understood that the invention in its broad aspect includes mechanical and functional equivalents of the elements described herein. Moreover, although the invention has been described in the particular application of a beverage dispenser, it should be understood that the invention may be used in various other applications.

I/We claim:

1. A product dispenser, comprising:
a user interface for entering a selection of a desired product among available products by a user;
a control unit operatively connected to the user interface for receiving the selection of the desired product, generating a command indicative of the desired product, and generating a barcode identifying the desired product;
a dispenser unit for storing the available products and providing the user with the desired product upon reception of the command from the control unit; and
a printing unit operatively connected to the control unit, the printing unit for printing the barcode on a coupon and providing the user with the coupon.

2. The product dispenser of claim 1, wherein the barcode is indicative of at least one of a price of the desired product and an identification of the desired product.

3. The product dispenser of claim 2, wherein the coupon has further written information printed thereon, the written information comprising at least one of a name of the desired product, a time, and a date at which the coupon has been printed.

4. The product dispenser of claim 2, further comprising a communication unit for receiving and transmitting data to an administrator machine for remotely controlling the product dispenser from the administrator machine, at least one of the price and the identification for the available products being remotely changeable from the administrator machine.

5. The product dispenser of claim 4, wherein the control unit is adapted to store user consumption data and transmit the user consumption data to the administrator machine via the communication unit.

6. The product dispenser of claim 4, further comprising sensors for monitoring at least one of malfunctions and an amount of remaining products, the control unit being further adapted to transmit indications of the at least one of malfunctions and an amount of remaining products to the administrator machine via the communication unit.

7. The product dispenser of claim 1 further comprising an identifier reader for identifying the user.

8. The product dispenser of claim 1, wherein the dispenser unit is adapted to prepare beverages according to recipes stored in the control unit.

9. The product dispenser of claim 8, wherein the dispenser unit comprises a storage module for storing coffee beans, a grinder module for grinding the coffee beans received from the storage module, a hot water module connectable to a source of water and adapted to heat water, and a brewer module for brewing the ground coffee received from the grinder module in the hot water received from the hot water module.

10. The product dispenser of claim 9, wherein the dispenser unit further comprises a cup ejecting module for storing cups and ejecting a cup on a platform.

11. A method for generating a coupon indicative of a purchase, the method comprising:
receiving at an automatic product dispenser a selection for a desired product among available products, the selection being provided via a user interface of the automatic product dispenser;
generating a barcode identifying the desired product;
printing the barcode on a coupon; and
providing the selected product and the coupon having the barcode printed thereon.

12. The method of claim 11, wherein said generating a barcode comprises generating a barcode indicative of at least one of a price of the desired product and an identification of the desired product.

13. The method of claim 12, further comprising printing written information on the coupon, the written information comprising at least one of a name of the desired product and a time and a date at which the coupon has been printed.

14. The method of claim 12, further comprising receiving and transmitting data to an administrator machine so that the automatic product dispenser be remotely controllable from the administrator machine, at least one of the price and the identification for the available products being remotely changeable from the administrator machine.

15. The method of claim 14, further comprising storing user consumption data and transmitting the user consumption data to the administrator machine.

16. The method of claim 14, further comprising monitoring at least one of malfunctions and an amount of remaining products and transmitting the at least one of malfunctions and an amount of remaining products to the administrator machine.

17. The method of claim 11, further comprising identifying a purchaser of the desired product.

18. The method of claim 11, wherein said providing the selected product comprises preparing a desired beverage according to a recipe stored in the automatic product dispenser.

19. The method of claim 18, wherein said preparing the desired beverage comprises:
storing coffee beans in a storage module;
grinding the coffee beans received from the storage module, thereby obtaining ground coffee;
heating water to a desired temperature, thereby obtaining hot water;
brewing the ground coffee in the hot water, thereby obtaining a brewed coffee.

20. The method of claim 19, further comprising:
storing cups in a cup ejecting module;
ejecting one of the cups on a platform; and
pouring the brewed coffee in the ejected cup.

21. A method for making a payment at point-of-sale terminal provided with a barcode reader, comprising:
receiving data corresponding to a barcode printed on a coupon and resulting from a scan of the barcode by the barcode reader, the barcode being indicative of a product selected by a user at an automatic product dispenser and delivered to the user by the automatic product dispenser;
determining a price for the selected product using the received data; and
receiving a payment from the user.
